(19) United States
(12) Patent Application Publication
(10) Pub. No.: US 2013/0078042 A1
(43) Pub. Date: Mar. 28, 2013

(54) METHOD IN A WASTE CONVEYING SYSTEM, A WASTE CONVEYING SYSTEM AND A VACUUM SOURCE FOR A WASTE CONVEYING SYSTEM

(71) Applicant: Göran Sundholm, Tuusula (FI)

(72) Inventor: Göran Sundholm, Tuusula (FI)

(73) Assignee: MARICAP OY, Vantaa (FI)

(21) Appl. No.: 13/700,704

(22) PCT Filed: Jun. 1, 2011
(86) PCT No.: PCT/FI11/50512

§ 371 Date: Nov. 28, 2012

(30) Foreign Application Priority Data
Jun. 3, 2010 (FI) 20105631

(51) Int. Cl. B60P 1/60

(52) U.S. Cl. CPC B60P 1/60
USPC 406/41; 406/39; 406/42

(57) ABSTRACT

Method in a pneumatic waste conveying system, which conveying system comprises at least one input point (61) of waste material, a material conveying pipe (100), which can be connected to an input point (61), and a separating device or container (25), in which the material to be conveyed is separated from the conveying air, and also means for achieving a pressure difference and/or a conveying air flow in the conveying pipe (100) at least during the conveyance of material, which means comprise at least one vacuum source. In the method a vacuum source (1) is arranged in a mobile means (2), such as in a vehicle or trailer, which vacuum source is connected to a waste conveying system, and the partial vacuum/pressure difference needed for the transfer of waste material is achieved in the system, in which case waste material is transferred along the conveying piping (100, 100A, 100B, 100C, 100D, 100E, 100F) to a container (25), which is a separate container to the means (2) moving the vacuum source.

### BACKGROUND OF THE INVENTION

The object of the invention is a method, as defined in the preamble of claim 1, in a pneumatic waste conveying system.

The object of the invention is also a waste conveying system as defined in the preamble of claim 11.

The object of the invention is also a vacuum source, as defined in the preamble of claim 23, for a waste conveying system.

The invention relates generally to pneumatic material conveying systems, such as to partial-vacuum conveying systems, more particularly to the collection and conveying of wastes, such as to the conveying of household wastes.

Systems wherein wastes are conveyed in piping by means of suction and/or conveying air are known in the art. In these, wastes are moved long distances in the piping pneumatically, by means of suction and/or a pressure difference, together with the conveying air. The apparatuses are used for, among other things, the conveying of wastes in different institutions. It is typical to these systems that a partial-vacuum apparatus is used to achieve a pressure difference, in which apparatus a partial vacuum is achieved in the conveying pipe with partial-vacuum generators, such as with vacuum pumps or with an ejector apparatus. A conveying pipe typically comprises at least one valve means, by opening and closing which the replacement air coming into the conveying pipe is adjusted. One of the convenient solutions of new regional building projects is waste management that will operate with a pipe transport system. This means that sorted wastes are sucked along underground pipes to a waste station that is common to the whole region. The system is clean, odorless and noise-free, and is also a more environmentally friendly solution than conventional waste management and a safer solution from the viewpoint of the adjacent area. In regional building sites in which it has been decided to use a pneumatic pipe transport system in waste transportation, it is typical that it is necessary to build conveying piping to completion and a shared waste station for the region even though the whole construction project would progress slowly and in stages. In this case it is necessary to build the system to completion in respect of the conveying piping and the waste station, although the construction project might last for years or even decades. The capacity of the piping and of the waste station of the system has, however, been made ready taking into account the amount of users to be realized at some time in the future. A waste station is conceived to typically comprise also means for achieving a pressure difference in the piping, e.g. partial-vacuum generators, such as vacuum pumps or corresponding. In this case in the initial phase of a construction project a situation is encountered wherein it is necessary to make sizable investments in equipment, even though the designed full capacity will not be needed in the system for years yet. On the other hand, there are a lot of quite small sites, such as office properties, commercial properties, industrial properties and especially residential properties, in which it is desired to achieve a pipe transport solution for wastes, but which are not economically viable to equip with their own partial-vacuum generating apparatus. A system is know in the art, wherein the suction devices of a partial-vacuum system are connected to a container vehicle, which goes to suck wastes at regular intervals, e.g. daily, into its own container and transports them away. These types of solutions are presented e.g. in publication EP0093825 A1, in which a vehicle provided with vacuum means goes to empty a container disposed below a refuse chute. On the other hand, a corresponding solution is known from publication WO 2006/135296, wherein a collection vehicle is provided with vacuum means and goes to suck the wastes of a system into its own container. The vehicles of this solution typically both suck, compress and transport waste. The vehicles are very large, heavy and noisy. This makes the vehicles needed awkward to use in cramped spaces, such as in old city centers. In addition, the vehicles needed become expensive in terms of costs.

The aim of the present invention is to achieve a new type of solution in connection with material conveying systems, by means of which solution the drawbacks of prior art solutions are avoided.

### BRIEF DESCRIPTION OF THE INVENTION

The invention is based on a concept wherein the input points of a partial-vacuum conveying system are connected with a trunk pipe to a transport container and the vacuum needed for transferring wastes from the input points into the transport container is achieved with a mobile vacuum source, which can if necessary be moved between different conveying systems independently of the transport container.

The method according to the invention is characterized by what is disclosed in the characterization part of claim 1.

The method according to the invention is also characterized by what is stated in claims 2-10.

The waste conveying system according to the invention is characterized by what is disclosed in the characterization part of claim 11.

The material conveying system according to the invention is also characterized by what is stated in claims 12-22.

The vacuum source, according to the invention, for a material conveying system is characterized by what is disclosed in claim 23.

The vacuum source, according to the invention, for a material conveying system is also characterized by what is stated in claims 24-27.

The solution according to the invention has a number of important advantages. By means of the invention the drawbacks of prior-art solutions can be avoided. The mobile partial-vacuum generating apparatus can be used effectively in connection with a number of material conveying systems to achieve the partial vacuum needed in the pneumatic transportation of material. In this case a dedicated fixed partial-vacuum generating apparatus is not needed in individual material conveying systems. The system thus enables the division of effective operating time of the vacuum source between a number of material conveying systems. The system also enables the offering of the vacuum source of the material conveying system as a service to properties. In addition, the system enables an effective way to ensure material conveying by using a number of mobile vacuum sources, in which case e.g. in a malfunction situation a primary vacuum source can easily be replaced with a second mobile backup apparatus. The mobile vacuum source according to the invention fits to function in more cramped locations also because it can be arranged in a vehicle in which space for wastes is not needed at the same time. The solution according to the invention effectively enables a different frequency for operation of the vacuum source and for emptying of a container. By using material shapers to compact the waste material to be handled in connection with an input point, a smaller diameter of the conveying piping can be applied, in which case also the power requirement of the vacuum source is smaller. In this case the vacuum source is formed to be smaller in its size and weight, in which case moving is possible with a rather small vehicle. The container and the vacuum source can, according to the invention, be moved independently of each other. The wastes can be sucked, e.g. daily, into a separate container. The separate container can, in turn, be emptied, e.g. weekly, by transporting it separately. In a solution according to the invention an intermediate container is not needed, but instead waste is sucked directly into a transport container, which is then taken for emptying e.g. to a landfill site or to some other waste handling plant. The vacuum source can typically be e.g. a fan provided with motor output power in the region of 45 kW, while in prior-art solutions the power output must be several hundred kilowatts. Compared to prior-art solutions, in which the connecting parts to the piping are rather large in diameter (400-500 mm) and thus awkward to handle, in a solution according to the invention only a suction air connection, which is typically in the region of 100-150 mm in its diameter, is used for connecting to the vacuum source.

The solution according to the invention is suited for use in both conventional material conveying systems comprising one or more conveying pipes and in material conveying systems comprising ring piping.

### BRIEF DESCRIPTION OF THE FIGURES

In the following, the invention will be described in more detail by the aid of an example of its embodiment with reference to the attached drawings, wherein

FIG. 1 presents one system according to an embodiment of the invention as a simplified diagram,

FIG. 1a presents a simplified view of a part of the system according to the invention,

FIG. 1b presents a simplified view of a second part of the system according to the invention,

FIG. 2 presents a simplified diagram of one system according to an embodiment of the invention, in a second operating phase,

FIG. 2a presents a simplified view of a part according to the invention,

FIG. 3 presents a simplified diagram of one system according to an embodiment of the invention, in an operating phase, and

FIG. 4 presents a simplified diagram of one device of a system according to an embodiment of the invention.

### DETAILED DESCRIPTION OF THE INVENTION

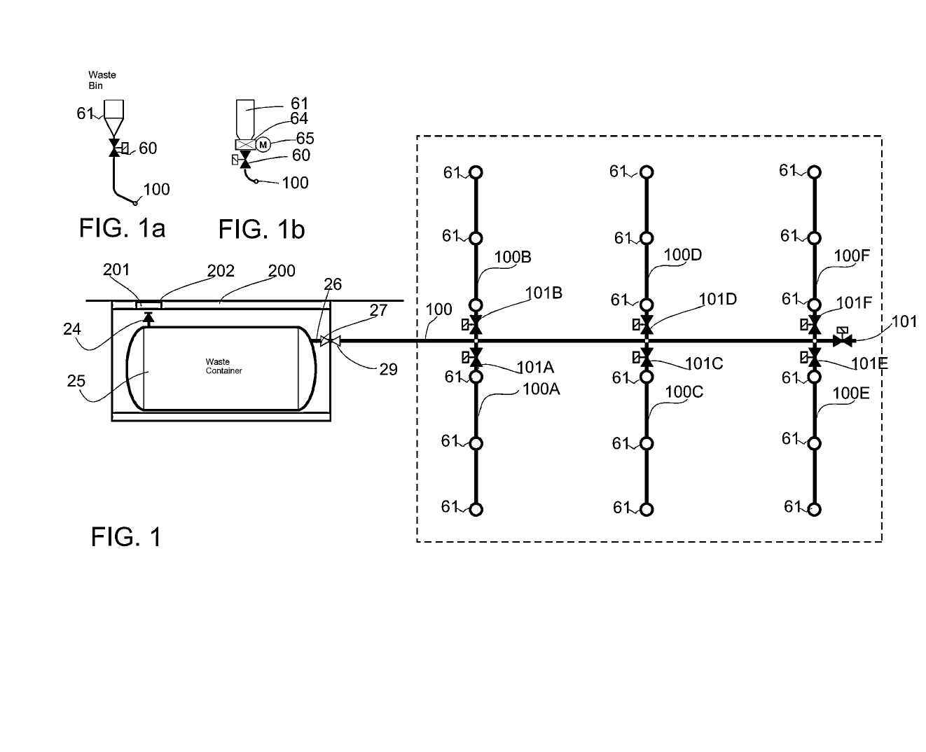

FIG. 1 presents a part of a pneumatic material conveying system, which part comprises a material conveying pipe 100, along the side of which at least one, typically many, input points 61 are arranged. An input point 61 is a feed-in station of material, more particularly of waste material, intended to be conveyed, from which station the material, more particularly waste material, such as household waste, intended to be conveyed is fed into the conveying system. The feed-in station 61 can also be a refuse chute, into which material is fed from input apertures on different floors of a building. The system can comprise a number of feed-in stations 61, from which the material intended to be conveyed is fed into conveying piping 100, 100A, 100B, 100C, 100D, 100E. A feed-in station 61 is marked in the figure with a dot, in which case by opening and closing a shut-off means, such as a valve means 60, that is possibly in connection with the feed-in station, material can be conveyed from an input point 61 into the conveying pipe 100. FIG. 1a presents one input point 61 to be used in an implementation of a system according to the invention and the discharge valve 60 of said input point in more detail.

FIG. 1b presents a second implementation of an input point 61 of a system according to the invention, in which a material shaper 64, preferably a rotary shaper, which is driven with a drive device 65, is also in connection with the input point. By means of the material shaper the waste material can be compacted or otherwise shaped to be better suited to the conveying pipe. By using a material shaper, the diameter of the conveying pipe can typically be reduced to the region of 150-300 mm, preferably to the region of 200 mm, while the diameter of conventional conveying piping (without a material shaper) is in the region of 500 mm. The material shaper is presented e.g. in patent applications FI 20100203, FI20105145 and FI20105570.

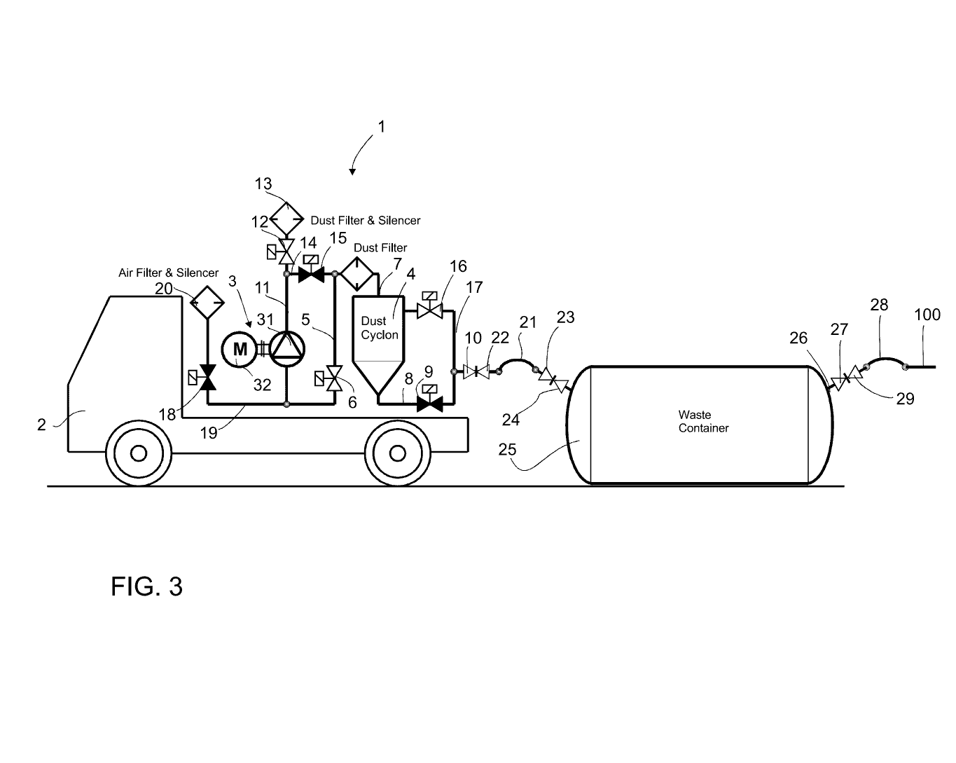

The input point is connected on the valve side to a conveying pipe 100 or to a pipe in connection with it. Typically conveying piping comprises a main conveying pipe 100, to which it has been possible to connect a number of branch conveying pipes 100A, 100B, 100C, 100D, 100E, 100F and in turn to which branch conveying pipes it has been possible to connect a number of feed-in stations 61. The conveying pipe 100 can be connected to a collection container 25, which in one implementation is also a transport container. A connecting means 29 is formed in the conveying pipe 100 and a counterpart 27 in the branch coupling 26 formed in the top part of the container 25. The connecting means 29 and the counterpart 27 together form a quick coupling. A flexible hose part 28 can be between the conveying pipe 100 and the connecting part 29, such as in the embodiment of FIG. 3

A second connection 24 is formed in the container 25, into which connection a pipe or hose coming from the vacuum source can be connected with a counterpart 23.

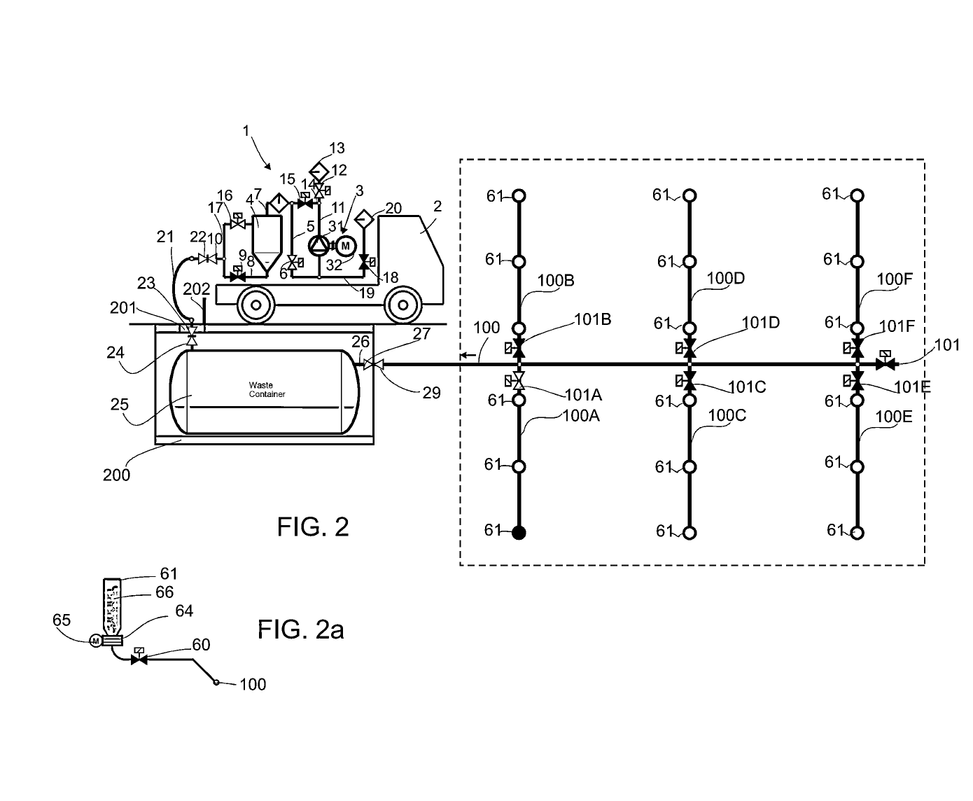

According to the invention the vacuum source 1 is mobile. According to the embodiment of FIG. 2 the vacuum source 1 is a mobile apparatus arranged in a vehicle 2. The vehicle 2 can be e.g. a small lorry or van or the vacuum source 1 can be arranged in a trailer, which can be towed by a vehicle. The vacuum source 1 in FIG. 2 comprises a pump unit 3, comprising a partial-vacuum generator 31, such as a vacuum pump, and the drive device 32 that drives it. The suction side of the partial-vacuum generator is connected in a first operating phase to a container 25 via a medium pathway 5. In this case the suction/pressure difference needed in the conveyance of material into the container 25 and into the conveying piping 100, 100A, 100B, 100C, 100D, 100E, 100F can be achieved. Between the partial-vacuum generator 31 and the transport container 25 is a separating device 4, such as a particle separator, in which some of the particles in the conveying air separate, e.g. due to the dropping of speed and due to centrifugal force, from the conveying air. The separated particles remain in the bottom part of the separating device 4, on the bottom of it, from where they can be removed, e.g. by blowing into the transport container. A mobile vacuum source 1 can be connected to a second connection 24 of the container 25 with a counterpart 23 arranged in the hose 21, which hose 21 is at its second end arranged into a connection part 10 of the vacuum source with a counterpart 22. From the connection part 10 of the vacuum source 1 there is a medium connection 17 to the top part of the separating device 4. In the embodiment of the figure, the medium connection 17 is provided with a valve means 16. Also a second medium connection 7 is arranged into the top part of the separating means 4 in the embodiment of the figure, which medium connection can be connected by means of a valve 6 to the medium pathways 5 on the suction side of the partial-vacuum generator 31. On the blowing side of the partial-vacuum generator 31 is a medium pathway 11 to the outlet line, which is provided in the embodiments of the figures with a valve means 12 and with filter means and sound attenuation means 13. According to a second embodiment the outlet line can be led to farther from the vacuum source, e.g. by arranging a coupling point in the outlet line of a mobile vacuum source for an outward blowing pipe. In this case outward blowing of exhaust air in the proximity of a partial-vacuum generator, e.g. at street level, can be avoided by leading the outward blowing pipe farther, e.g. to the roof of a property. The blowing side of a partial-vacuum generator of a mobile vacuum source can in this case be connected to an outward blowing pipe e.g. with a hose and a quick-coupling.

The partial-vacuum generator can, if necessary, be connected such that it blows into the separating device 4 via the pathways 11, 14, 7 of the medium. In this case the valve 12 of the outward blowing pipe is closed and the valve in the medium pathway 14 is opened. Blowing can be used e.g. to transfer particles that have collected in the separating device 4 along the pipe 8 via the connection 10 out of the partial-vacuum generator, e.g. into the container 25 or into some other emptying place. Via a corresponding connection the vacuum source can also be made to blow into the conveying piping 100, via the container 25 or directly.

The drive device 32 of the vacuum source can be a motor, e.g. an electric motor. The electricity needed is obtained in this case e.g. from the socket of an electricity network, which socket is situated most suitably in the proximity of the material conveying system to be emptied. The mobile means 2, such as a conveying vehicle, can also be wholly or partly driven by an electric motor, in which case its accumulators can be charged at the same time as the partial-vacuum generator 31 is used.

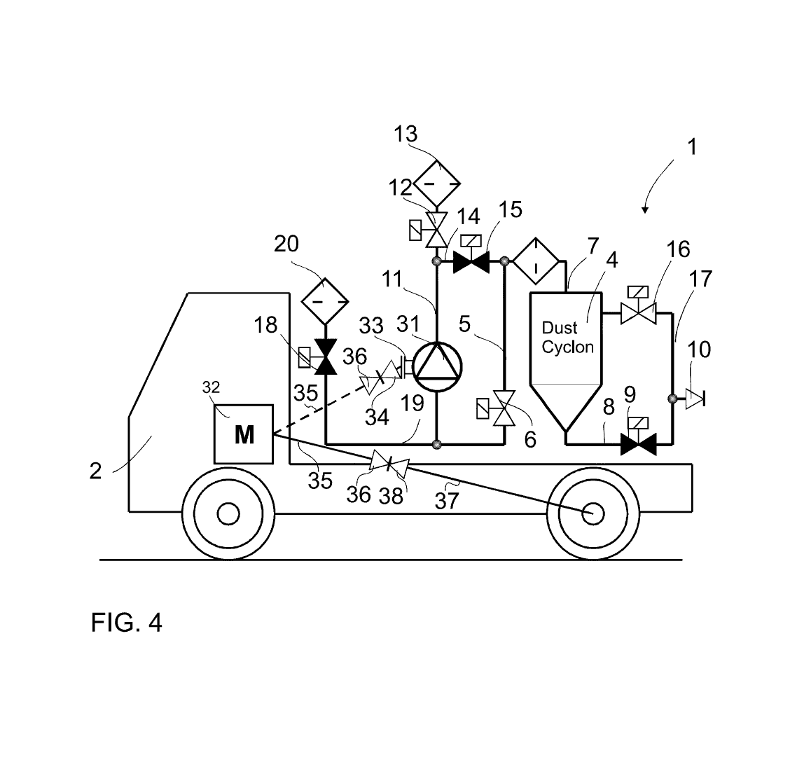

In the embodiment of FIG. 4 the drive device 32 of the partial-vacuum generator is the motor of a vehicle 2. The cardan shaft of the vehicle is formed from two parts 35, 37, which can be connected to each other by means of a quick-coupling 36, 38. The drive shaft 33 of the partial-vacuum generator 31 are disposed such that when the first part 35 of the cardan shaft is detached from the quick-coupling 36, 38, the first part 35 of the cardan shaft can be transferred for connection to the drive shaft 33 of the partial-vacuum generator 31 via a second quick-coupling (this position of the first part 35 of the cardan shaft is presented in FIG. 4 with a dashed line). In this case the motor of the vehicle 2 can be used as the drive device 32 of the partial-vacuum generator 31. According to the implementation of FIG. 4, the partial-vacuum generator can be used at the operating site even if electric current were not available from an electricity network.

The material fed in is conveyed along the conveying piping 100, 100A, 100B, 100C, 100D to a container 25, in which the material being conveyed separates, e.g. due to the dropping of speed and due to centrifugal force, from the conveying air.

In the embodiment of FIG. 1, a number of branch pipes 100A, 100B, 100C, 100D, 100E, 100F, which by means of the line valves 101A, 101B, 101C, 101D, 101E, 101F can be separated from or connected to the main conveying pipe 100, are connected to the main conveying pipe 100. In this case the emptying of the input points 61 of certain areas of the conveying piping and the conveying of the material of them along the conveying piping into the container 25 can be regulated. The conveying piping can also be of a different shape. The conveying piping and the vacuum source can, according to one embodiment, be connected to comprise a circuit, in which case also the blowing side of the vacuum source can be connected to a medium connection with the conveying piping such that conveying air can be circulated in the circuit.

The container 25 can be arranged according to FIG. 3 on the surface of the ground or in a separate space, e.g. below the ground surface, according to the embodiment of FIGS. 1 and 2. The container 25 can be transported with a normal lorry, or with some other vehicle, for emptying. A lifting/lowering device 200 is in connection with an underground location site. The lifting/lowering device comprises an aperture 201 provided with a shut-off means 202 for connecting the vacuum source to the counterparts of the container. When the container 25 has been filled, it is lifted up with a hoisting device 200, e.g. to ground level, for taking the container to be emptied. Correspondingly, an emptied container is placed into its location site and lowered back down with the lifting/lowering device. On the other hand, it can be conceived that the container is lowered down, e.g. to ground level, for emptying for the purpose of transportation. A connecting means 29 is formed in the conveying pipe 100 and a counterpart 27 in the branch coupling 26 formed in the top part of the container 25. The connecting means 29 and the counterpart 27 together form e.g. a quick coupling, in which case the quick coupling opens and/or closes automatically in the lifting and lowering of the container.

The figure presents an ordinary container 25, but it can also be provided with a press or then the site can have a press to which the container is connected. When it is desired to feed in wastes of large size, which do not fit into the piping, a filling aperture can be made in the container, e.g. in the top part of the container. In this case wastes of large size are fed directly into the container or are conveyed via a press into the container.

When the suction side of the partial-vacuum generator 31 is connected directly or via a conveying air duct to the container 25, to which the discharge end of a conveying pipe 100 is in turn connected, a partial vacuum is produced in the conveying pipe 100. In this case the suction acts in the conveying pipe 100 via the medium pathway connecting to the container. An area valve 101A is between the main conveying pipe 100 and the branch conveying pipe 100A, which valve is open in this operating phase. In this case the suction is able to act also in the branch conveying pipe 100A. In the case according to FIG. 2, when the valve means 60 of the point marked black is opened in an input point 61, the material batch (FIG. 2a) intended to be conveyed transfers into the branch conveying pipe 100A and onwards into the main conveying pipe 100. Possible replacement air into the conveying pipe comes e.g. via the input point 61 when opening the valve 60 to the conveying pipe. When the valve 60 of an input point is closed, the line valve 101 can be opened for receiving replacement air into the conveying pipe 100.

FIG. 2a presents one implementation of an input point 61 of a system according to the invention in which a material shaper 64, preferably a rotary shaper, which is driven with a drive device 65, is also in connection with the input point. By means of the material shaper the waste material 66 can be compacted or otherwise shaped to be better suited to the conveying pipe 100A, 100. In the system according to the invention, by using a material shaper smaller diameters of the conveying piping are achieved, in which case correspondingly the power requirement of the vacuum source is smaller.

The waste material is conveyed along the conveying piping 100A, 100 to the container 25, where the conveying air separates from the waste material and the waste material remains in the collector container 25 (FIG. 2).

When all the input points intended to be emptied have been emptied and the material is conveyed from the branch conveying pipe 100A into the conveying pipe 100, the area valve 101A can be closed and the area valve 101B of the branch conveying pipe 100B of the area intended to be emptied next can be opened. After the input points of this branch conveying pipe have been emptied into the conveying pipe 100B, 100 and conveyed in the piping onwards to the container 25 in a corresponding manner to that described above in connection with FIGS. 1 and 2, the area valve of the branch conveying pipe 101 B is closed and it is possible to move to the next area to be emptied by opening e.g. the area valve 101C of the branch conveying pipe 100C. The emptying sequence is continued until all the desired input points have been emptied.

The invention thus relates to a method in a pneumatic waste conveying system, which conveying system comprises at least one input point 61 of waste material, a material conveying pipe 100, which can be connected to an input point 61, and a separating device or container 25, in which the material to be conveyed is separated from the conveying air, and also means for achieving a pressure difference and/or a conveying air flow in the conveying pipe 100 at least during the conveyance of material, which means comprise at least one vacuum source. In the method a vacuum source 1 is arranged in a mobile means 2, such as in a vehicle or trailer, which vacuum source is connected to a waste conveying system, and the partial vacuum/pressure difference needed for the transfer of waste material is achieved in the system, in which case waste material is transferred along the conveying piping 100, 100A, 100B, 100C, 100D, 100E, 100F to a container 25, which is a separate container to the means 2 moving the vacuum source.

According to one embodiment in the method the container 25 is transferred with a second transport means onwards for emptying.

According to one embodiment in the method the drive device 32 used to move a mobile means 2 is used to produce at least a part of the drive power needed by the partial-vacuum generator 31 of the vacuum source 3.

According to one embodiment a drive device 32 receiving its driving force from an energy network is used to produce at least a part of the drive power needed by the partial-vacuum generator 31 of the vacuum source.

According to one embodiment the vacuum source 1 is used as the vacuum source of a number of different waste conveying systems, in which case the vacuum source 1 is transferred with mobile means 2 to the proximity of each waste conveying system and connected with connection means to a waste conveying system.

According to one embodiment the operating interval of the vacuum source 1 in connection with a waste conveying system is denser than the emptying interval of the container 25.

According to one implementation the vacuum source sucks wastes daily into a separate container 25, which is not connected to a vehicle. The separate container is emptied, e.g. weekly, separately.

According to one embodiment the material conveying piping comprises at least a main conveying pipe 100 and branch conveying pipes 100A, 100B, 100C, 100D, 100E, 100F that can be connected to it.

According to one embodiment in the method waste material is fed into a conveying pipe 100 from the input points 61 of material, which are the input points of waste, such as waste receptacles or refuse chutes.

According to one embodiment in the method the waste conveying system is a waste conveying system of a certain area or property.

According to one embodiment waste material is shaped after a waste input point 61 and before the conveying pipe 100 by conducting it to a material shaper 64, preferably to a rotary shaper, at least partly by means of gravity and/or by means of the suction or pressure difference produced by the vacuum source 1.

The invention also relates to a waste conveying system, which comprises at least one input point 61 of waste material, a material conveying pipe 100, which can be connected to an input point 61, and a separating device or container 25, in which the waste material to be conveyed is separated from the conveying air, and also means for achieving a pressure difference and/or a conveying air flow in the conveying pipe 100 at least during the conveyance of material, which means comprise at least one vacuum source. A vacuum source 1 is arranged in a mobile means 2, such as in a vehicle or trailer, which vacuum source comprises connection means for connecting the suction side of its partial-vacuum generator to a material conveying system such that the partial vacuum/pressure difference needed for the transfer of material can be achieved for transferring waste material along the conveying piping 100, 100A, 1008, 100C, 100D, 100E, 100F to a container 25, which is a separate container to the means 2 moving the vacuum source.

According to one embodiment the container 25 is a transport container, and is fitted for transporting with transport means onwards for emptying.

According to one embodiment the drive device 32 of the mobile means 2 is fitted to produce at least a part of the drive power needed by the partial-vacuum generator 31 of the vacuum source 3.

According to one embodiment the drive device 32 is fitted to receive its driving force from an energy network and to produce at least a part of the drive power needed by the partial-vacuum generator 31 of the vacuum source.

According to one embodiment the vacuum source 1 is fitted to function as the vacuum source of a number of different waste conveying systems such that the vacuum source is transferred with mobile means 2 to the proximity of each waste conveying system for connecting with connection means to a waste conveying system.

According to one embodiment the input points 61 of material are the input points of waste, such as waste receptacles or refuse chutes.

According to one embodiment the material conveying piping comprises at least a main conveying pipe 100 and branch conveying pipes 100A, 100B, 100C, 100D, 100E, 100F that can be connected to it.

According to one embodiment the waste conveying system is a waste conveying system of a certain area or property.

According to one embodiment in the system the container 25 is arranged to be lifted/lowered by means of the lifting/lowering device 200 of the container to/from ground level.

According to one embodiment a connecting means 29 is formed in the conveying pipe 100 and a counterpart 27 in the branch coupling 26 formed in the top part of the container 25, which connecting means 29 and counterpart 27 together form a quick coupling, in which case the quick coupling opens and/or closes automatically in the lifting and lowering of the container 25.

According to one embodiment the container 25 is provided with a press.

According to one embodiment a material shaper 64, preferably a rotation shaper, is arranged in connection with a waste input point 61 or after it and before the conveying pipe 100.

The object of the invention is also a vacuum source for a waste conveying system, which comprises a partial-vacuum generator and a drive device of the partial-vacuum generator, and also means for connecting the vacuum source to a material conveying system. A vacuum source 1 is arranged in a mobile means 2, such as in a vehicle or trailer.

According to one embodiment the mobile means is a vehicle, the drive device 32 of which is fitted to produce at least a part of the drive power needed by the partial-vacuum generator 31 of the vacuum source 3.

According to one embodiment the drive device 32 of the vacuum source is an electric motor, which is fitted to receive its driving force from an energy network and to produce at least a part of the drive power needed by the partial-vacuum generator 31 of the vacuum source.

According to one embodiment the drive shaft 33 of the partial-vacuum generator 31 of the vacuum source is arranged to connect by means of a quick coupling 34, 36 to a cardan shaft 35, which leaves from the drive device 32 of the mobile means 2.

According to one embodiment the mobile means 2 is a vehicle operating with at least a partly electrically-driven drive motor, the accumulators of which electric motor are fitted to charge when a vacuum source is used.

It is obvious to the person skilled in the art that the invention is not limited to the embodiments presented above, but that it can be varied within the scope of the claims presented below. The characteristic features possibly presented in the description in conjunction with other characteristic features can, if necessary, also be used separately to each other.

1. Method in a pneumatic waste conveying system, which conveying system comprises at least one input point (61) of waste material, a material conveying pipe (100), which can be connected to an input point (61), and a separating device or container (25), in which the material to be conveyed is separated from the conveying air, and also means for achieving a pressure difference and/or a conveying air flow in the conveying pipe (100) at least during the conveyance of material, which means comprise at least one vacuum source, comprising to the following steps:
arranging a vacuum source (1) in a mobile means (2), such as in a vehicle or trailer,
connecting the vacuum source to a waste conveying system, and
achieving a partial vacuum/pressure difference needed for the transfer of waste material in the system, in which case waste material is transferred along the conveying piping (100, 100A, 100B, 100C, 100D, 100E, 100F) to a container (25), which is a separate container to the means (2) moving the vacuum source.

2. Method according to claim 1, wherein the method the container (25) is transferred with a second transport means onwards for emptying.

3. Method according to claim 1, wherein the method the drive device (32) used to move a mobile means (2) is used to produce at least a part of the drive power needed by the partial-vacuum generator (31) of the vacuum source (3).

4. Method according to claim 1, wherein a drive device (32) receiving its driving force from an energy network is used to produce at least a part of the drive power needed by the partial-vacuum generator (31) of the vacuum source.

5. Method according to claim 1, wherein the vacuum source (1) is used as the vacuum source of a number of different waste conveying systems, in which case the vacuum source (1) is transferred with mobile means (2) to the proximity of each waste conveying system and connected with connection means to a waste conveying system.

6. Method according to claim 1, wherein the operating interval of the vacuum source (1) in connection with a waste conveying system is denser than the emptying interval of the container (25).

7. Method according to claim 1, wherein the material conveying piping comprises at least a main conveying pipe (100) and branch conveying pipes (100A, 100B, 100C, 100D, 100E, 100F) that can be connected to it.

8. Method according to claim 1, wherein the method waste material is fed into a conveying pipe (100) from the input points (61) of material, which are the input points of waste, such as waste receptacles or refuse chutes.

9. Method according to claim 1, wherein the method the waste conveying system is a waste conveying system of a certain area or property.

10. Method according to claim 1, wherein waste material is shaped after a waste input point (61) and before the conveying pipe (100) by conducting it to a material shaper (64), preferably to a rotary shaper, at least partly by means of gravity and/or by means of the suction or pressure difference produced by the vacuum source (1).

11. Waste conveying system, which comprises at least one input point (61) of waste material, a material conveying pipe (100), which can be connected to an input point (61), and a separating device or container (25), in which the waste material to be conveyed is separated from the conveying air, and also means for achieving a pressure difference and/or a conveying air flow in the conveying pipe (100) at least during the conveyance of material, which means comprise at least one vacuum source, comprising:
a vacuum source (1) is arranged in a mobile means (2), such as in a vehicle or trailer, which vacuum source comprises connection means for connecting the suction side of its partial-vacuum generator to a material conveying system such that the partial vacuum/pressure difference needed for the transfer of material can be achieved for transferring waste material along the conveying piping (100, 100A, 100B, 100C, 100D, 100E, 100F) to a container (25), which is a separate container to the means (2) moving the vacuum source.

12. System according to claim 11, wherein the container (25) is a transport container, and is fitted for transporting with transport means onwards for emptying.

13. System according to claim 11, wherein the drive device (32) of the mobile means (2) is fitted to produce at least a part of the drive power needed by the partial-vacuum generator (31) of the vacuum source (3).

14. System according to claim 11, wherein the drive device (32) is fitted to receive its driving force from an energy network and to produce at least a part of the drive power needed by the partial-vacuum generator (31) of the vacuum source.

15. System according to claim 11, wherein the vacuum source (1) is fitted to function as the vacuum source of a number of different waste conveying systems such that the vacuum source is transferred with mobile means (2) to the proximity of each waste conveying system for connecting with connection means to a waste conveying system.

16. System according to claim 11, wherein the input points (61) of waste material are the input points of waste, such as waste receptacles or refuse chutes.

17. System according to claim 11, wherein the material conveying piping comprises at least a main conveying pipe (100) and branch conveying pipes (100A, 100B, 100C, 100D, 100E, 100F) that can be connected to it.

18. System according to claim 11, wherein the waste conveying system is a waste conveying system of a certain area or property.

19. System according to claim 11, wherein the system the container (25) is arranged to be lifted/lowered by means of the lifting/lowering device (200) of the container to/from ground level.

20. System according to claim 19, wherein a connecting means (29) is formed in the conveying pipe (100) and a counterpart (27) in the branch coupling (26) formed in the top part of the container (25), which connecting means (29) and counterpart (27) together form a quick coupling, in which case the quick coupling opens and/or closes automatically in the lifting and lowering of the container (25).

21. System according to claim 11, wherein the container (25) is provided with a press.

22. System according to claim 11, wherein a material shaper (64), preferably a rotation shaper, is arranged in connection with a waste input point (61) or after it and before the conveying pipe (100).

23. Vacuum source for a waste conveying system, which vacuum source comprises a partial-vacuum generator and a drive device of the partial-vacuum generator, and also means for connecting the vacuum source to a material conveying system, wherein the vacuum source (1) is arranged in a mobile means (2), such as in a vehicle or trailer.

24. Vacuum source according to claim 23, wherein the mobile means is a vehicle, the drive device (32) of which is fitted to produce at least a part of the drive power needed by the partial-vacuum generator (31) of the vacuum source 3).

25. Vacuum source according to claim 23, wherein the drive device (32) of the vacuum source is an electric motor, which is fitted to receive its driving force from an energy network and to produce at least a part of the drive power needed by the partial-vacuum generator (31) of the vacuum source.

26. Vacuum source according to claim 23, wherein the drive shaft (33) of the partial-vacuum generator (31) of the vacuum source is arranged to connect by means of a quick coupling (34, 36) to a cardan shaft (35), which leaves from the drive device (32) of the mobile means (2).

27. Vacuum source according to claim 23, wherein the mobile means (2) is a vehicle operating with at least a partly electrically-driven drive motor, the accumulators of which electric motor are fitted to charge when a vacuum source is used.
